(19) United States
(12) Patent Application Publication
(10) Pub. No.: US 2008/0253680 A1
(43) Pub. Date: Oct. 16, 2008

(54) Determining Relevance Values

(75) Inventor: Jeroen Arnoldus Paulus Tegenbosch, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,597

(22) PCT Filed: Jan. 31, 2005
(86) PCT No.: PCT/IB2005/050400

§ 371 Date: Aug. 1, 2006

(30) Foreign Application Priority Data
Feb. 6, 2004 (EP) 04100450.8

(51) Int. Cl. G06K 9/40

(52) U.S. Cl. 382/263; 382/254

(57) ABSTRACT

A pixel relevance determining unit (100) for determining relevance values for respective pixels of an image is disclosed. The pixel relevance determining unit (100) comprises edge determining means (102) for determining a first edge orientation for a first one of the pixels (300) on basis of a first group of pixel values and for determining a second edge orientation for a second one of the pixels (308) on basis of a second group of pixel values, the second one of the pixels (308) being located in a neighborhood of the first one of the pixels (300); and assigning means (104) for assigning a first one of the relevance values corresponding to the first one of the pixels (300), on basis of comparing the first edge orientation with the second edge orientation.

The invention relates to a pixel relevance determining unit for determining relevance values for respective pixels of an image.

The invention further relates to an image processing apparatus comprising:

receiving means for receiving a signal representing an image;

a pixel relevance determining unit for determining relevance values for respective pixels of the image, a pixel relevance determining unit as described above; and

filtering means for computing an output image on basis of the image and on basis of the relevance values. such a determining unit.

The invention further relates to a method of determining relevance values for respective pixels of image.

The invention further relates to a computer program product to be loaded by a computer arrangement, comprising instructions to determine relevance values for respective pixels of an image, the computer arrangement comprising processing means and a memory.

An embodiment of the method of the kind described in the opening paragraph is known from the US patent U.S. Pat. No. 6,192,162. In this patent specification is disclosed that pixels are classified on basis of computed parameters. The computed parameters correspond to orientations of transients within the luminance values around the pixels of the image. That means that for each pixel under consideration at least two orientations are computed by subtracting pairs of pixel values of pixels which are located respectively horizontally or vertically related to the pixel under consideration. The computed orientation values are compared with thresholds to classify the corresponding pixels in one of the possible classes. Subsequently the assigned pixel classification values of the pixels are used to derive a boost value for image enhancement. A disadvantage of the known classification method is that it is sensitive to noise.

It is an object of the invention to provide a pixel relevance determining unit of the kind described in the opening paragraph which is less sensitive to noise.

This object of the invention is achieved in that the pixel relevance determining unit comprises:

edge determining means for determining a first edge orientation for a first one of the pixels on basis of a first group of pixel values and for determining a second edge orientation for a second one of the pixels on basis of a second group of pixel values, the second one of the pixels being located in a neighborhood of the first one of the pixels; and

assigning means for assigning a first one of the relevance values corresponding to the first one of the pixels, on basis of comparing the first edge orientation with the second edge orientation.

The assignment of relevance values, i.e. the classification of a relevance, is based on comparing the estimated orientations of the neighboring pixels. That means that the estimated second edge orientation of the neighboring second one of the pixels is taken into account for classification of the first one of the pixels. Typically, the assigning means is arranged to assign a relatively high relevance value to the first one of the pixels if an angle between the first edge orientation and the second edge orientation is relatively small. That means that if the difference between the first edge orientation and the second edge orientation is relatively small, the relevance value for the first one of the pixels is relatively high. This is based on the assumption that real edges extend over a relatively high number of pixels while noise is random which results in un-correlated pixel value differences between neighboring pixels.

Typically the first one of the pixels and the second one of the pixels are connected. With connected the following is meant. In general, a pixel in an image is connected to 8 neighboring pixels, i.e. 2 pixels being horizontally located relative to the pixel, 2 pixels being vertically located relative to the pixel and 4 pixels being diagonally located relative to the pixel.

In an embodiment of the pixel relevance determining unit according to the invention, the first group of pixel values corresponds to respective luminance values of a first group of pixels surrounding the first one of the pixels. Optionally the luminance value of the first one of the pixels is also applied to compute the first edge orientation. Typically the first group of pixels are symmetrically disposed around the first one of the pixels in a kernel with an aperture of 3*3 or 5*5 pixels. The second group of pixel values corresponds to respective luminance values of the second group of pixels surrounding the second one of pixels. Typically the first group of pixels partly overlaps with the second group of pixels.

In an other embodiment of the pixel relevance determining unit according to the invention, the first group of pixel values corresponds to respective color values of a first group of pixels surrounding the first one of the pixels. Optionally, both luminance and color values are used for edge detection and estimation of edge orientations.

In an embodiment of the pixel relevance determining unit according to the invention, the assigning means is arranged to assign a relatively low relevance value to the first one of the pixels if a steepness of a first edge corresponding to the first one of the pixels, is below a predetermined threshold. Besides comparing edge orientations of neighboring pixels, also the steepness of the edge is taken into account for classification. If the difference between the pixels of the first group of pixels is relatively low, i.e. there is only a small transient, then the edge is considered to be not or hardly relevant. That results in a relatively low relevance value.

Typically, the edge determining means comprises a high pass filter. For instance one or more Sobel filters.

It is a further object of the invention to provide an image processing apparatus comprising a pixel relevance determining unit of the kind described in the opening paragraph which is less sensitive to noise.

This object of the invention is achieved in that the pixel relevance determining unit comprises:

edge determining means for determining a first edge orientation for a first one of the pixels on basis of a first group of pixel values and for determining a second edge orientation for a second one of the pixels on basis of a second group of pixel values, the second one of the pixels being located in a neighborhood of the first one of the pixels; and

assigning means for assigning a first one of the relevance values corresponding to the first one of the pixels, on basis of comparing the first edge orientation with the second edge orientation.

It is a further object of the invention to provide a method of the kind described in the opening paragraph which is less sensitive to noise.

This object of the invention is achieved in that the method comprises:

determining a first edge orientation for a first one of the pixels on basis of a first group of pixel values and for determining a second edge orientation for a second one of the pixels oh basis of a second group of pixel values, the second one of the pixels being located in a neighborhood of the first one of the pixels;

assigning a first one of the relevance values corresponding to the first one of the pixels, on basis of comparing the first edge orientation with the second edge orientation.

It is a further object of the invention to provide a computer program product of the kind described in the opening paragraph which is less sensitive to noise.

This object of the invention is achieved in that the computer program product, after being loaded, providing said processing means with the capability to carry out:

determining a first edge orientation for a first one of the pixels on basis of a first group of pixel values and for determining a second edge orientation for a second one of the pixels on basis of a second group of pixel values, the second one of the pixels being located in a neighborhood of the first one of the pixels;

assigning a first one of the relevance values corresponding to the first one of the pixels, on basis of comparing the first edge orientation with the second edge orientation.

Modifications of the pixel relevance determining unit and variations thereof may correspond to modifications and variations thereof of the image processing apparatus, the method and the computer program product, being described.

These and other aspects of the pixel relevance determining unit, of the image processing apparatus, of the method and of the computer program product, according to the invention will become apparent from and will be elucidated with respect to the implementations and embodiments described hereinafter and with reference to the accompanying drawings, wherein:

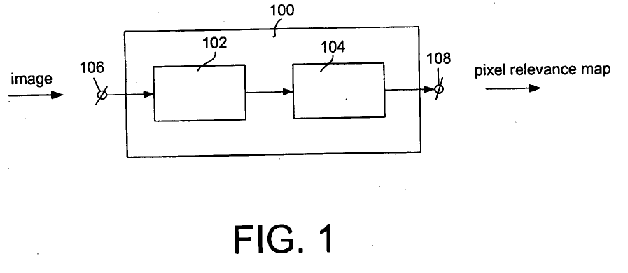

FIG. 1 schematically shows an embodiment of the pixel relevance determining unit according to the invention;

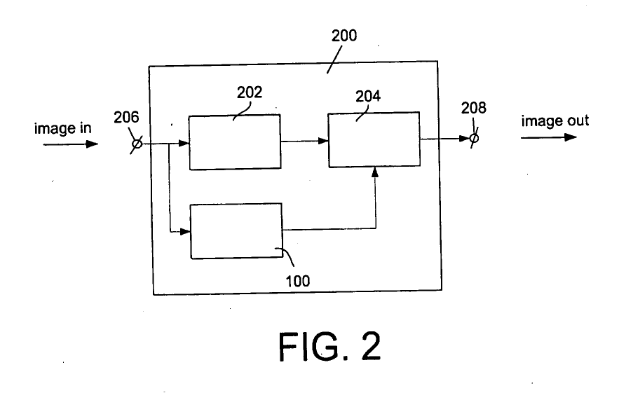

FIG. 2 schematically shows an embodiment of an image enhancement unit comprising a pixel relevance determining unit according to the invention;

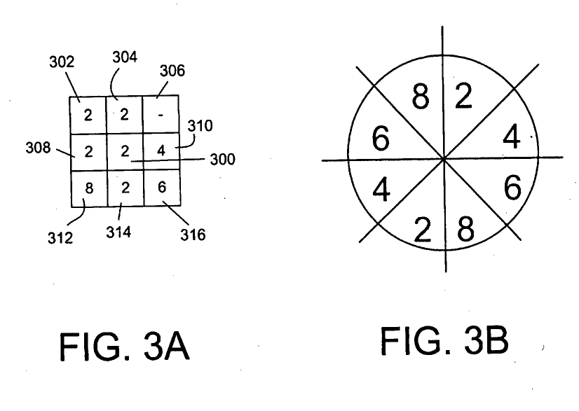

FIG. 3A schematically shows a group of pixels of an image;

FIG. 3B schematically shows a number of edge orientations; and

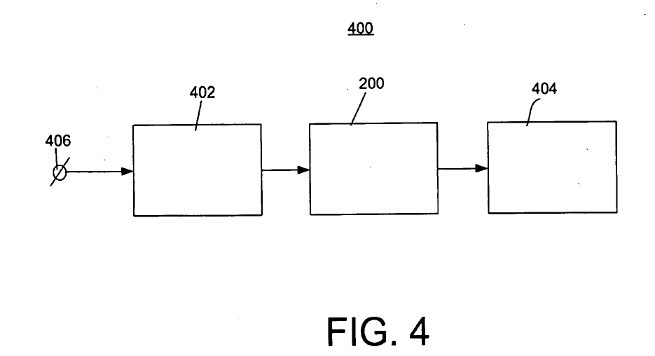

FIG. 4 schematically shows an image processing apparatus according to the invention.

Same reference numerals are used to denote similar parts throughout the figures.

FIG. 1 schematically shows an embodiment of the pixel relevance determining unit 100 according to the invention. The pixel relevance determining unit 100 is provided with image data at its input connector 106. This image data might corresponds to a still picture. Alternatively the image data corresponds to a sequence of video images. The pixel relevance determining unit is arranged to compute a pixel relevance map for each image. A pixel relevance map is a two dimensional array of a relevance values. Each element of the two dimensional array corresponds to a respective pixel of an input image. The pixel relevance map is provided at the output connector 108 of the pixel relevance determining unit 100.

The pixel relevance determining unit 100 comprises:

an edge orientation computing unit 102 for computing edge orientations for the pixels of the input images; and

a pixel relevance assigning unit 104 for assigning relevance values corresponding to the pixels of the input image on basis of the computed edge orientations.

The edge orientation computing unit 102 is arranged to determine a first edge orientation for a first one of the pixels on the image on basis of a first group of pixel values and for determining a second edge orientation for a second one of the pixels on basis of a second group of pixel values, whereby the second one of the pixels is located in a neighborhood of the first one of the pixels. The edge orientation computing unit 102 is preferably based on a combination of Sobel filters of which the kernel coefficients are:

$$[ \begin{matrix}- 1 & 0 & 1 \\ - 1 & 0 & 1 \\ - 1 & 0 & 1\end{matrix} ] and [ \begin{matrix}- 1 & - 1 & - 1 \\ 0 & 0 & 0 \\ 1 & 1 & 1\end{matrix} ] or [ \begin{matrix}- 1 & 0 & 1 \\ - 2 & 0 & 2 \\ - 1 & 0 & 1\end{matrix} ] and [ \begin{matrix}- 1 & - 2 & - 1 \\ 0 & 0 & 0 \\ 1 & 2 & 1\end{matrix} ]$$

The edge orientation computing unit 102 further comprises means for clipping minor output signals of the Sobel filters and computing means for computing the ratio between the two clipped outputs of the two Sobel filters. The value of such ratio is directly related to the edge orientation, which is assigned as temporal result to the corresponding pixel being located at the center of the kernels. After the edge orientations for a particular pixel and for the pixels to which the particular pixel is connected, are computed the eventual relevance value for the particular pixel is computed by the pixel relevance assigning unit 104. This pixel relevance assigning unit 104 is described in more detail in connection with FIGS. 3A and 3B. Preferably, the pixels of the image are processed in a row by row or column by column scan.

To summarize, the pixel relevance determining unit 100 is arranged to determine the relevance of the pixels of an image. The relevance of a particular pixel depends on whether this particular pixel belongs to an edge and whether the edge orientations of surrounding pixels substantially match with the edge orientation of this particular pixel. The pixel relevance map is preferably used to control image enhancement. Relevant pixels are enhanced while typically irrelevant pixels are not enhanced or even blurred. Preferably the amount of enhancement is directly related with the relevance value. Experiments have shown that the noisy images lose a lot of noise while the sharpness remains and that images with relatively many blocking artifacts lose most of these blocking artifacts while again the sharpness remains and that clean images, i.e. with hardly any noise, remain their sharpness.

FIG. 2 schematically shows an embodiment of an image enhancement unit 200 comprising a pixel relevance determining unit 100 according to the invention. The image enhancement unit 200 is provided with input images at its input connector 206 and is arranged to provide output images at its output connector 208. The image enhancement unit 200 comprises a low pass filter 202 which is arranged to compute low pass filtered intermediate images on basis of the provided input images. The pixel relevance determining unit 100 is arranged to compute pixel relevance maps, as described in connection with FIG. 1, for the respective images. The image enhancement unit 200 further comprises a high pass filter 204, i.e. a peaking filter, which is arranged to compute the output images on basis of the low pass filtered intermediate images and the respective pixel relevance maps. The high pass filter 204 is controlled on a pixel base, that means that the amount of peaking for each pixel is determined by the corresponding pixel relevance value. If for a particular pixel the pixel relevance value is relatively high, then the peaking gain is also relatively high.

The edge orientation computing unit 102, the pixel relevance assigning unit 104, the low pass filter 202 and the high pass filter 204 may be implemented using one processor. Normally, these functions are performed under control of a software program product. During execution, normally the software program product is loaded into a memory, like a RAM, and executed from there. The program may be loaded from a background memory, like a ROM, hard disk, or magnetically and/or optical storage, or may be loaded via a network like Internet. Optionally an application specific integrated circuit provides the disclosed functionality.

FIG. 3A schematically shows a group of pixels 300-316 of an image. There is one central pixel 300 and 8 neighboring pixels 302-316 which are connected to this central pixel 300. FIG. 3A depicts the values 2,4,6,8 of the edge orientations being estimated for the different pixels 300-316 of the group. For one 306 of the neighboring pixels no edge orientation could be computed. That means that the result of the edge computation for that one 306 of the neighboring pixels was below a predetermined threshold. The meaning of the edge orientation values are depicted in FIG. 3B, i.e. the segments of the circle correspond to edge orientations. It can be seen that the central pixel 300 has been assigned an edge orientation being equal to the value 2. Four neighboring pixels 302, 304, 308 and 314 have been assigned the same edge orientation, i.e. 2. These four neighboring pixels contribute relatively much to the pixel relevance value of the central pixel 300, because they have the same edge orientation. The right neighboring pixel 310 differs slightly from the edge orientation of the central pixel. Hence, the contribution of this particular pixel is less than the respective contributions of the other four pixels 302, 304, 308 and 314 mentioned above. The same applies for the pixel with reference number 312. The contribution of the pixel with reference member 316 is even less.

In other words the relevance value of the central pixel 300 is computed by comparing its edge orientation with the respective edge orientations of its neighbors. The relevance value of the central pixel 300 is computed by accumulation of match results. In total there are eight matches performed, i.e. with each of the connected neighboring pixels 302-316. The match results depends on the difference between the edge orientation of the central pixel 300 and the respective neighboring pixels 302-316. The pixel relevance assigning unit 104 as depicted in FIG. 1 is arranged to perform the matching and accumulation of these type of match results.

It should be noted that matching with more than these eight neighboring pixels is possible. Alternatively not all neighboring pixels are taken into account. A further alternative is based on taking into account temporal neighboring pixels, i.e. pixels from other images of a sequence of images to which the image under consideration belongs. In that case the apertures a so-called spatio-temporal aperture.

FIG. 4 schematically shows an embodiment of the image processing apparatus 400 according to the invention, comprising:

Receiving means 402 for receiving a signal representing input images.

The image enhancement unit 200 as described in connection with FIG. 2; and

A display device 404 for displaying the output images of the image processing unit 200.

The signal may be a broadcast signal received via an antenna or cable but may also be a signal from a storage device like a VCR (Video Cassette Recorder) or Digital Versatile Disk (DVD). The signal is provided at the input connector 406. The image processing apparatus 400 might e.g. be a TV. Alternatively the image processing apparatus 400 does not comprise the optional display device but provides the output images to an apparatus that does comprise a display device 406. Then the image processing apparatus 400 might be e.g. a set top box, a satellite-tuner, a VCR player, a DVD player or recorder. Optionally the image processing apparatus 400 comprises storage means, like a hard-disk or means for storage on removable media, e.g. optical disks. The image processing apparatus 400 might also be a system being applied by a film-studio or broadcaster.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware. The usage of the words first, second and third, etcetera do not indicate any ordering. These words are to be interpreted as names.

1. A pixel relevance determining unit (100) for determining relevance values for respective pixels of an image, the pixel relevance determining unit (100) comprising:
edge determining means (102) for determining a first edge orientation for a first one of the pixels (300) on basis of a first group of pixel values and for determining a second edge orientation for a second one of the pixels (308) on basis of a second group of pixel values, the second one of the pixels (308) being located in a neighborhood of the first one of the pixels (300); and
assigning means (104) for assigning a first one of the relevance values corresponding to the first one of the pixels (300), on basis of comparing the first edge orientation with the second edge orientation.

2. A pixel relevance determining unit (100) as claimed in claim 1, wherein the assigning means (104) is arranged to assign a relatively high relevance value to the first one of the pixels (300) if an angle between the first edge orientation and the second edge orientation is relatively small.

3. A pixel relevance determining unit (100) as claimed in claim 1, wherein the first group of pixel values corresponds to respective luminance values of a first group of pixels (302-316) surrounding the first one of the pixels (300).

4. A pixel relevance determining unit (100) as claimed in claim 1, wherein the first group of pixel values corresponds to respective color values of a first group of pixels (302-316) surrounding the first one of the pixels (300).

5. A pixel relevance determining unit (100) as claimed in claim 1, wherein the edge determining means (102) comprises a high pass filter.

6. A pixel relevance determining unit (100) as claimed in claim 2, wherein the assigning means (104) is arranged to assign a relatively low relevance value to the first one of the pixels (300) if a steepness of a first edge corresponding to the first one of the pixels (300), is below a predetermined threshold.

7. An image processing apparatus (400) comprising:
receiving means (402) for receiving a signal representing an image;
a pixel relevance determining unit (100) for determining relevance values for respective pixels of the image, the pixel relevance determining unit (100) as claimed in claim 1; and
filtering means (204) for computing an output image on basis of the image and on basis of the relevance values.

8. An image processing apparatus (400) as claimed in claim 7, wherein the filtering means comprises peaking means, a peaking gain of the peaking means for a particular pixel of the image depending on a particular relevance value being assigned to the particular pixel.

9. A method of determining relevance values for respective pixels of an image, the method comprising:
determining a first edge orientation for a first one of the pixels (300) on basis of a first group of pixel values and for determining a second edge orientation for a second one of the pixels (308) on basis of a second group of pixel values, the second one of the pixels (308) being located in a neighborhood of the first one of the pixels (300);
assigning a first one of the relevance values corresponding to the first one of the pixels (300), on basis of comparing the first edge orientation with the second edge orientation.

10. A computer program product to be loaded by a computer arrangement, comprising instructions to determine relevance values for respective pixels of an image, the computer arrangement comprising processing means and a memory, the computer program product, after being loaded, providing said processing means with the capability to carry out:
determining a first edge orientation for a first one of the pixels (300) on basis of a first group of pixel values and for determining a second edge orientation for a second one of the pixels (308) on basis of a second group of pixel values, the second one of the pixels (308) being located in a neighborhood of the first one of the pixels (300);
assigning a first one of the relevance values corresponding to the first one of the pixels (300), on basis of comparing the first edge orientation with the second edge orientation.
